(19) United States
(12) Patent Application Publication
(10) Pub. No.: US 2025/0338108 A1
(43) Pub. Date: Oct. 30, 2025

(54) Ultra-Fast Multi-Radio Contextual Discovery

(71) Applicant: Dell Products L.P., Round Rock, TX (US)

(72) Inventors: Harpreet S. Narula, Austin, TX (US); Brian E. Manser, Round Rock, TX (US)

(73) Assignee: Dell Products L.P., Round Rock, TX (US)

(21) Appl. No.: 18/650,624

(22) Filed: Apr. 30, 2024

(51) Int. Cl. H04W 8/00; H04W 4/12; H04W 84/12

(52) U.S. Cl. CPC H04W 8/005; H04W 4/12; H04W 84/12

(57) ABSTRACT

Embodiments are directed to devices that use a common advertisement packet that can be discovered by both Bluetooth and Wi-Fi type scanners. In one configuration, a device comprises a first radio associated with a first wireless interface, and a second radio associated with a second wireless interface. At least one processor is coupled to the first radio and the second radio. The at least one processor is configured to cause the device to scan the first wireless interface for advertisement messages, and receive an advertisement message from a remote station. The advertisement message comprises information identifying a service available via the second radio and identifying a social channel on the second wireless interface to establish the service.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, internet of things (IoT) monitoring and communications, or global communications. In addition, information handling systems can include a variety of hardware and software resources that can be configured to process, store, and communicate information and can include one or more computer systems, graphics interface systems, data storage systems, and networking systems. Information handling systems can also implement various virtualized architectures. Data communications among information handling systems may be via networks that are wired, wireless, optical or some combination.

### SUMMARY

Embodiments are directed to devices that use a common advertisement packet that can be discovered by both Bluetooth and Wi-Fi type scanners. In one configuration, a device comprises a first radio associated with a first wireless interface, and a second radio associated with a second wireless interface. At least one processor is coupled to the first radio and the second radio. The at least one processor is configured to cause the device to scan the first wireless interface for advertisement messages, and receive an advertisement message from a remote station. The advertisement message comprises information identifying a service available via the second radio and identifying a social channel on the second wireless interface to establish the service.

One some arrangements, one wireless interface is a Bluetooth interface, and the other wireless interface is a Wi-Fi interface. A Bluetooth radio may be used to discover an infrastructure device, and a Wi-Fi Direct discovery on the Wi-Fi interface is triggered by a context in the advertisement message.

In various use cases, the service is associated with a low power mode of the device, motion of the device, an application running on the device, or a location of the device, such as a distance between the device and the remote station. In various embodiments, the device may be an Information Handling System (IHS), an access point, a wireless docking station, an infrastructure device, or a collaboration bar.

The at least one processor may be further configured to cause the device to exchange discovery messages with the remote station on the social channel on the second wireless interface.

The advertisement message may be a Contextual Low Power Advertisement (CLPA) message that uses an organization identifier field to define the service available and uses a channel information field to specify a service-related discovery channel. The CLPA message may be sent over a Bluetooth interface or over a Wi-Fi interface.

The device may further include multiple antennas associated with the first radio. The at least one processor may be further configured to cause the device to select one of the multiple antennas to scan the first wireless interface for the advertisement messages and to not use other of the multiple antennas to scan.

The at least one processor may be further configured to cause the device to place the second radio in an off or standby state while scanning the first wireless interface for advertisement messages using the first radio and to place the second radio in an on state after the social channel is identified.

In another embodiment, an apparatus includes one or more processors and one or more computer-readable storage media, such as system memory, having computer-executable instructions stored thereon that, when executed by the one or more processors, causes the processors to perform a method for using a common advertisement packet. The instructions cause the processor to advertise a service on a first wireless interface. The service is provided via a second wireless interface. The second wireless interface is a higher power interface than the first wireless interface. The service is advertised using a message format that can be used by both Bluetooth and Wi-Fi radios. The instructions further cause the processor to receive response information via the first wireless interface, wherein the response information indicates a subscription to the service from a wireless station, and to provide instructions to establish a data path to support the service via the second wireless interface. The service may be advertised using a CLPA message that uses an organization identifier field to define the service available and uses a channel information field to specify a service-related discovery channel. The apparatus may be an access point, a wireless docking station, an infrastructure device, or a collaboration bar.

The processor may be further configured to establish a peer-to-peer connection on the second wireless interface.

The processor may be further configured to place a radio for the second wireless interface in an off or standby state while advertising the service, and to place the radio in an on state when the response information indicates a subscription to the service.

The service may be associated with one or more of a low power mode, a location of the wireless station, a distance to the wireless station, motion of the wireless station or the apparatus, and an application running on the wireless station.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating two devices that are capable of communicating with each other using multiple radios.

FIG. 2 illustrates an advertisement packet (ADV) that can be adapted for use over both Bluetooth and Wi-Fi radios.

FIG. 3 illustrates a protocol flow for BLE triggering P2P discovery for an example embodiment using devices having collocated Wi-Fi and BLE capabilities.

FIG. 4 illustrates a GATT server that is configured to enable Wi-Fi Direct Discovery Advertisements over BLE transport by adding a TDS Service.

FIG. 5 illustrates an example use case for advertisement packets that can be used by participants to collaborate during a meeting.

FIG. 6 illustrates an example use case showing multiple devices collaborating in a group to share media.

FIG. 7 illustrates another example use case showing a group of devices using a common advertisement packet that can be used to trigger certain services or transport depending on the location of devices.

FIG. 8 shows an example of an Information Handling System (IHS) configured to implement systems and methods described herein for creating, sharing, receiving, and responding to a common advertisement packet that can be discovered on multiple radio scanner types.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

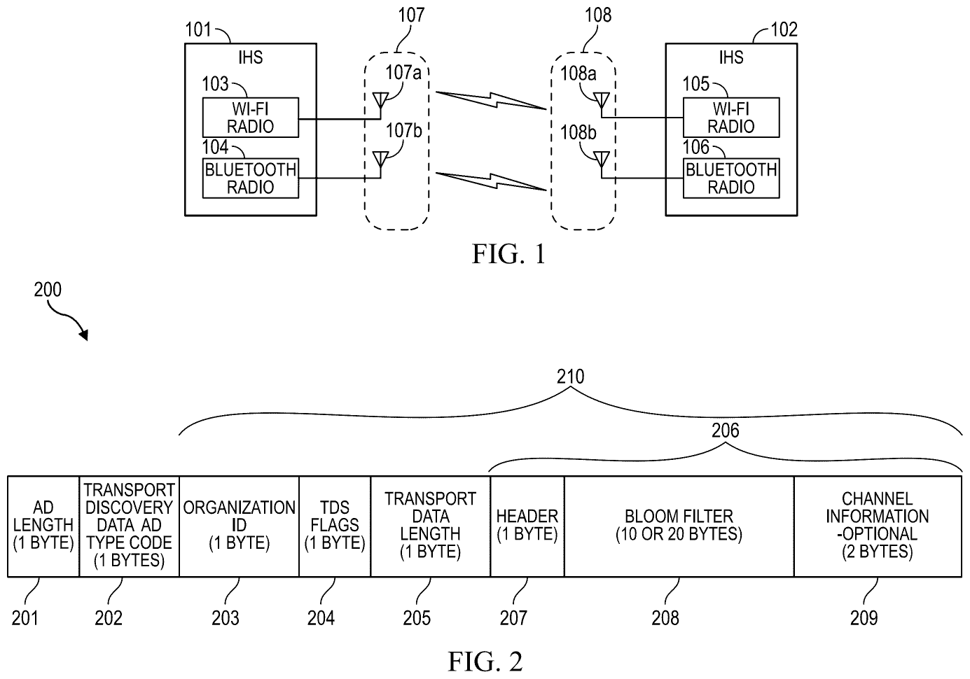

FIG. 1 is a high level block diagram illustrating two devices 101, 102 that are capable of communicating with each other using multiple radios. For example, device 101 has a Wi-Fi radio 103 and a Bluetooth radio 104, and device 102 has a Wi-Fi radio 105 and a Bluetooth radio 106. In one embodiment, devices 101, 102 are Information Handling Systems (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as a personal or enterprise workstation, media playing and editing, financial transaction processing, enterprise data storage, global communications, etc. In addition, IHSs may include a variety of hardware and software components that may be configured to process, store, and communicate information and may include one or more computer systems, data storage systems, and networking systems.

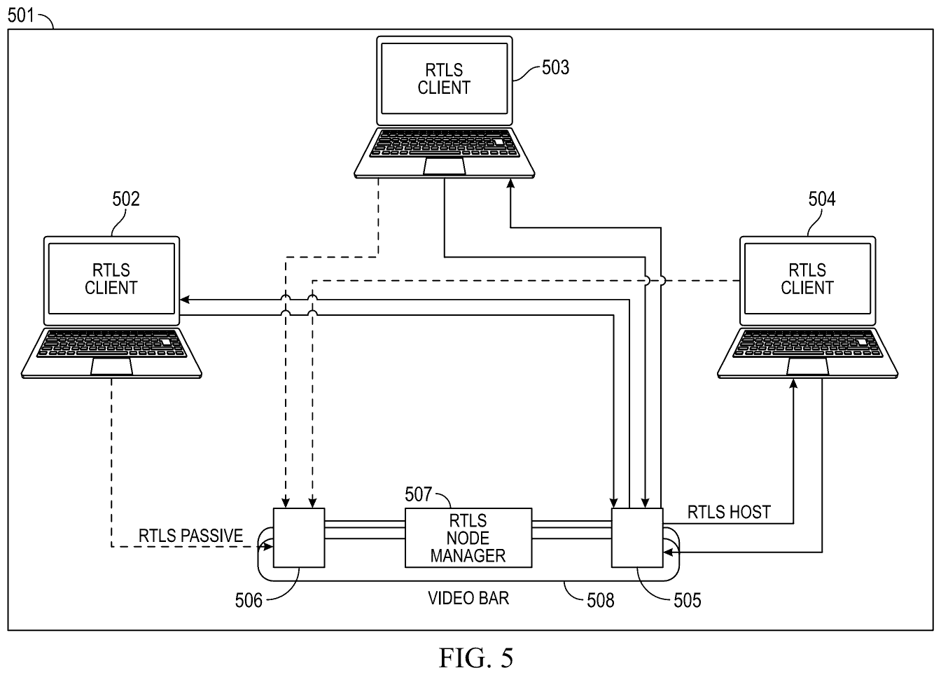

It will be understood that devices 101 and 102 are referred to as an IHS in FIG. 1 merely to illustrate on embodiment. In other embodiments, devices 101, 102 may be a collaboration bar, such as video bar 508 (FIG. 5), an access point or wireless docking station, such as component 701 (FIG. 7), or any other infrastructure or mobile device.

As used herein, the Wi-Fi radios 103, 105 refer to some or all of the transceiver and related processing circuitry and components that are required for devices 101, 102 to communicate using the IEEE 802.11x standards. Wi-Fi connections are typically established over the 2.4 GHz or 5 GHz bands. The 5 GHz band has 23 channels for devices to use, while the 2.4 GHz band has only 11 channels. There is an additional 6 GHz band available for device compliant with newer standards.

The Bluetooth radios 104,1 06 refer to some or all of the transceiver and related processing circuitry and components that are required for devices 101, 102 to communicate using the specifications formalized by the Bluetooth Special Interest Group (SIG). Bluetooth operates in the 2.4 GHz band. The classic Bluetooth operates on 79 1-MHz channels, while Bluetooth Low Energy (BLE) operates on 40 2-MHz channels, which includes three advertising channels and 37 data channels. Generally, Bluetooth devices consume less power than Wi-Fi. Moreover, BLE was specifically designed to have low energy consumption, which can lead to Wi-Fi devices using ten times more power than BLE devices. This variation in power consumption can be significant when one or both devices 101, 102 are battery powered.

The Wi-Fi radios 103, 105 include antenna components 107a, 108a, and the Bluetooth radios include antenna components 107b, 108b. In some configurations, a Wi-Fi radio and Bluetooth radio within the same device 101, 102 may share antenna elements so that there is a single antenna 107, 108 for each device. Devices 101, 102 may further share other radio design elements, such as front-end filters and antenna tuners. Use of the shared design elements cause delay due to switching and settling time required for various filters and tuners. Using the systems and methods disclosed herein can avoid the switching of radio and related sub-circuits and filters, thereby resulting in faster discovery of devices.

While FIG. 1 illustrates two devices 101, 102 in communication with each other, in other embodiments additional devices may also be in communication with these devices 101, 102 using either Wi-Fi radios or Bluetooth radios or both. The systems and methods disclosed herein provide a solution for fast discovery for collaboration and shared experiences for co-located devices 101, 102, such as co-located Wi-Fi/BLE-capable devices. This avoids radio switching and related filter and settling time and allows for robust connectivity using antenna diversity. The fast discovery enables lower power consumption because the Bluetooth radio 104, 106 can be used for Wi-Fi discovery. A social channel allows for application specific discovery to enable a robust peer-to-peer (P2P) setup process.

Embodiments use a common advertisement packet from the IHS devices 101, 102, which can be discovered by both Bluetooth and Wi-Fi radios. The advertisement packet can be sent using either Bluetooth or Wi-Fi radios from the IHS devices 101, 102. It may be preferred to use a Bluetooth radio to lower power consumption.

FIG. 2 illustrates an advertisement packet 200 (ADV) that can be adapted for use over both Bluetooth and Wi-Fi radios without requiring any changes to the Bluetooth or Wi-Fi standards. The Transport Discovery Service (TDS) enables devices using BLE wireless technology to expose services that are available on a transport other than BLE. The term “transport” refers to a communication technology that can be used for data transfers. TDS can be used to facilitate discovery and utilization transports not defined by the Bluetooth SIG, such as those defined by the Wi-Fi Alliance® or other organizations.

Wi-Fi standards allow for using BLE TDS to trigger a Neighbor Awareness Networking (NAN) radio. Wi-Fi NAN allows devices to discover services in their proximity and is built on the interaction of NAN devices grouped in clusters. Clusters are automatically created by nearby NAN devices that cooperate to synchronize to a common Discovery Window (DW) schedule. A wireless device may send NAN discovery communications during the discovery window associated with advertisement of the wireless devices. During the discovery window, all NAN devices participating in the cluster are allowed to exchange service frames describing or requesting a service. Within a NAN cluster, a NAN device can operate under different roles which entail different responsibilities: Master or Non-Master.

Advertisement packet 200 includes several subsections. The Advertising Data (AD) length 201 specifies the length of a particular packet 200. The Transport Discovery Data AD Type code 202 enables a client to determine the role of the device (i.e., whether it is seeking a service or providing a service), the organization and transport associated with the service, and other information such as the transport state and other features.

The Organization ID field 203 typically contains a Bluetooth SIG assigned numbers with value set for the appropriate organization. Table 1 lists assigned values for the Organization ID field 203. Each of the values 0x03-0xFF may be assigned to particular use cases, such as a device that is operating in Low-Power Mode, in a specific location, in motion, or with a certain application operating.

TABLE 1

| Value | Definition |
|---|---|
| 0x00 | Reserved for Future Use |
| 0x01 | Bluetooth SIG |
| 0x02 | Wi-Fi Alliance |
| 0x03-0xFF | Use-Case Context |

The TDS Flags field 204 represents the role of the device and information about its state and supported features. For example, the TDS Flags field 204 may include bits for indicating seeker/provider status, indicating additional data in GATT, indicating the availability of alternate transport. The Transport Data Length field 205 represents the total number of octets in the Transport Data field, which allows a scanning device to determine the length of the variable field that follows.

A Transport Data field 206 contains up to 26 bytes of organization-specific data, which may include a Header field 207, a variable length Bloom Filter field 209, and an optional Channel Information field 210. The Header field 207 is one byte long, and the individual bits specify content of the Transport Data field 206 as shown in Table 2. When the B7 bit is set, it tells the receiver to look for Social Discovery Channel information in the Channel Information field 210.

TABLE 2

| Bit | Definition |
|---|---|
| B0 | Bloom Filter Length Bit |
| B1-B6 | Reserved |
| B7 | Channel Info Present Bit |

The Bloom Filter elements 208 are case-sensitive text strings describing the services being offered, searches being discovered, and/or the services being activated. The strings use the following format as defined in the Wi-Fi Aware™ Specification Version 4.0:
<operation>[;<parameters]:<service name>%<data link identifier>.

The <operations> element comprises string values that identity actions by a browser (b), provider (p), or seeker(s). The [;<parameters] element comprises a BLE address string. The <service name> element comprises a defined service name. In the illustrated example, “_ipp._tcp” is used as a service name. The <data link identifier> is a text string indicating the data link being offered or requested. In the illustrated example, “nan” is used for an ipp service over NAN, and “p2p” is used for a service of P2P transport.

The Channel Information field 210 carries Social Discovery Channel information for P2P discovery. Channel Information field 210 can be pre-defined or configured by users for one or more underlying use-cases to allow for interference free discovery. The Social Discovery Channel information is unique for different contexts or user experiences (i.e., different use cases).

A Transport Block 210 includes the Organization ID field 203, TDS Flags 204, Transport Data Length 205, and Transport Data field 206. One or more Transport Blocks 210 may be present in the Transport Discovery Data AD Type field 202. The Transport Block 210 structure may be repeated in case there are multiple services to advertise simultaneously. These Transport Blocks may be from the same organization or from different organizations.

The same advertisement packet 200 can be used to trigger Wi-Fi Direct, which enables Wi-Fi devices to connect directly to each other. Wi-Fi Direct discovery can be triggered by setting the Transport Discovery Data AD Type code 202 to Contextual Low-Power Advertisement (CLPA). CLPA may specify various use-cases, such as: when a device operating in Low-Power Mode, when a device in a specific location (e.g., on-premises), when a device in motion, when a certain application is started on the device, or a combination of one of more of these conditions.

The Organization ID 203 can be used to define to underlying use case. The Channel Information filed 209 can be used to identify the use-case operating channel or P2P social channel if that channel is different from a default social channel.

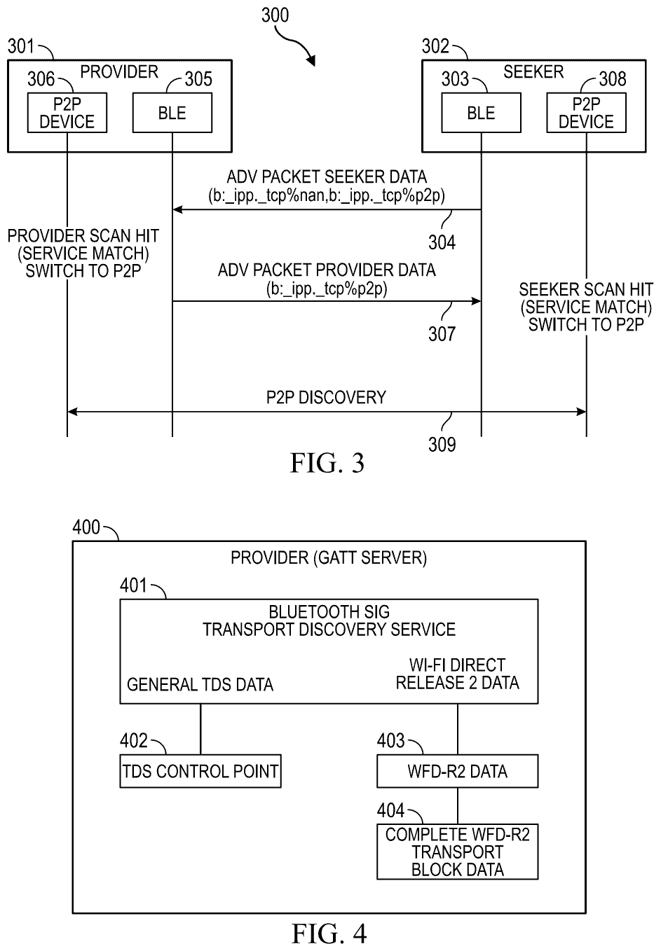

FIG. 3 illustrates a protocol flow 300 for BLE triggering P2P discovery for an example embodiment using devices 301, 302 having collocated Wi-Fi and BLE capabilities. Generally, either device can act as a Provider (ADV) or Seeker (Scan). In the illustrated example, device 301 is the provider and device 302 is the seeker. The application context (Host/Client configuration) can be used to set the role for P2P discovery. Initially, seeker device 302 is active (seeker start) and its BLE radio 303 sends an advertisement packet 304 that is received by BLE radio 305 in provider device 301. The Bloom filter field 208 in ADV packet 304 contains (b:_ipp._tcp%nan,b:_ipp._tcp%p2p), which indicates a browser trying to discover an ipp service over NAN or P2P. Provider 301 has a P2P service available using Wi-Fi radio 306, so there is a hit by Provider 301 while scanning advertisement packet 304 and a match to the P2P service on Wi-Fi radio 306.

Provider 301 responds with advertisement packet 307 (provider start). ADV packet 307 includes response data: (b:_ipp._tcp%p2p) in Bloom filter field 208 to notify Seeker device 302 that there is a service match for a P2P service on Wi-Fi radio 308. At this point, both Provider 301 and Seeker 302 have switched to the P2P service and P2P discovery 309 can begin between radios 306 and 308.

This process allows the Seeker 301 to scan and advertise only on BLE and then find and establish the P2P transport using BLE. When the device requires a P2P connection, such as to exchange a high rate of data, the devices switch to Wi-Fi and the P2P transport.

Bluetooth uses the TDS to expose data via advertising. The Generic Attribute Profile (GATT) establishes how data will be organized and exchanged over a BLE connection. The GATT can be used to facilitate a connection handover from the BLE transport to another transport.

FIG. 4 illustrates a GATT server 400 that is configured to enable Wi-Fi Direct Discovery Advertisements over BLE transport by adding a TDS Service. GATT server 400 stores attribute data locally and provides data access methods to remote GATT clients paired via BLE. A GATT client accesses data on GATT server 400 using read, write, notify, or indicate operations. The attributes in GATT server 400 are grouped into services, each of which can contain zero or more characteristics. The characteristics, in turn, can include zero or more descriptors. GATT services group conceptually related attributes in one common section of the attribute information set in GATT server 400. Characteristics are containers for user data that include at least two attributes: the characteristic declaration (metadata about the actual user data) and the characteristic value (a full attribute that contains the user data in its value field). The characteristic value can be followed by descriptors that further expand on the metadata contained in the characteristic declaration. The declaration, value, and any descriptors together form the characteristic definition, which is the bundle of attributes that make up a single characteristic.

GATT server 400 includes the Bluetooth TDS service 401, which enables a device using BLE wireless technology to expose services that are available on a transport other than BLE. Bluetooth TDS service 401 has two characteristics: TDS control point 402 for general TDS data and Wi-Fi Direct Release 2 (WFD-R2) data 403. The WFD-R2 data characteristic further includes the Complete WFD-R2 Transport Block Data descriptor 404. The TDS Control Point characteristic 402 allows the GATT server 400 to detect CLPA with discovery TDS.

In an example configuration, client devices, such as IHSs, include collocated Wi-Fi and Bluetooth radios and both technologies have their own discovery procedures. A multi-device experience is directed to P2P connectivity and fast discovery and setup. However, existing IHS devices with multiple radios require sequential device discovery across those radios, which are not locally synchronized and have to adapt with the external devices. The systems and methods disclosed herein use a common advertising packet, which can be sent using Bluetooth or Wi-Fi radios and which discovered by both without requiring changes to either wireless standard.

By providing a single advertisement packet that can be used for different use cases, wireless devices can enable faster and lower-power discovery. A CLPA packet can be used to enable specific use cases. For example, CLPA can be enabled to indicate when a device is in low power mode, when a device is in specific location, when the device is in motion, when a certain application is started on the device, or a combination of one or more of these conditions.

The advertisement packet may have a configurable rate, which would allow for faster advertisements without requiring switching.

For P2P discovery between two IHS devices, application context can be used wherein each client can advertise while a host device acts as infrastructure.

Power conservation can be achieved in multi-radio devices by having one of the device's radio stay off for lower power operation. Then, that radio can be turned on when an advertisement discovery response is received.

The advertisement packet can be used to improve interactions with an infrastructure device, such as a collaboration bar, wireless dock, Access Point (AP), or other special infrastructure equipment: A software service on the device parses the CLPA to determine an underlying discovery context and then triggers connectivity. For example, a Bluetooth radio may be used for device discovery and, depending on the context, Wi-Fi Direct Discovery can be triggered once the devices discover each other.

Antenna diversity can also be used depending on an expected use case or an application context. For example, a device with multiple antennas may select to use an antenna that has a higher spectral content in the direction of the expected advertisement packet and would thereby avoid switching antennas.

As noted above, the advertisement packet can be configured using CLPA to identify social discovery channels to allow for faster P2P connections.

FIG. 5 illustrates an example use case for CLPA advertisement packets that can be used by participants to collaborate during a meeting. A meeting room 501 includes three users with devices 502-504, which are Real-Time Location System (RTLS) client devices. RTLS is used to automatically identify and track the location of objects or people in real time, usually within a room, building, or other contained area. In one embodiment, RTLS clients 502-504 communicate with an RTLS host 505 over BLE, which allows the RTLS host 504 to identify and locate clients 502-504. RTLS passive 506 monitors the BLE connection with clients 502-504. An RTLS node manager 507 provides a bridge between the RTLS system and a host system, such as a video bar 508.

When devices 502-504 are located within meeting room 501 using the BLE RTLS system, advertising packets may be included in the RTLS communication to provide additional information to devices 502-504. For example, a CLPA advertisement packet may be used to send information about how to devices 502-504 can quickly join video bar 508. The CLPA advertisement packet may identify a social discovery channel, for example, that the video bar 508 is using to connect to client devices. An RTLS software application on RTLS clients 502-504 can send and receive advertisement packets. Information about video bar 508 can be extracted from the advertisement packet and passed to a collaboration application that would allow devices 502-504 to share videos over a separate Wi-Fi transport with a video bar 508.

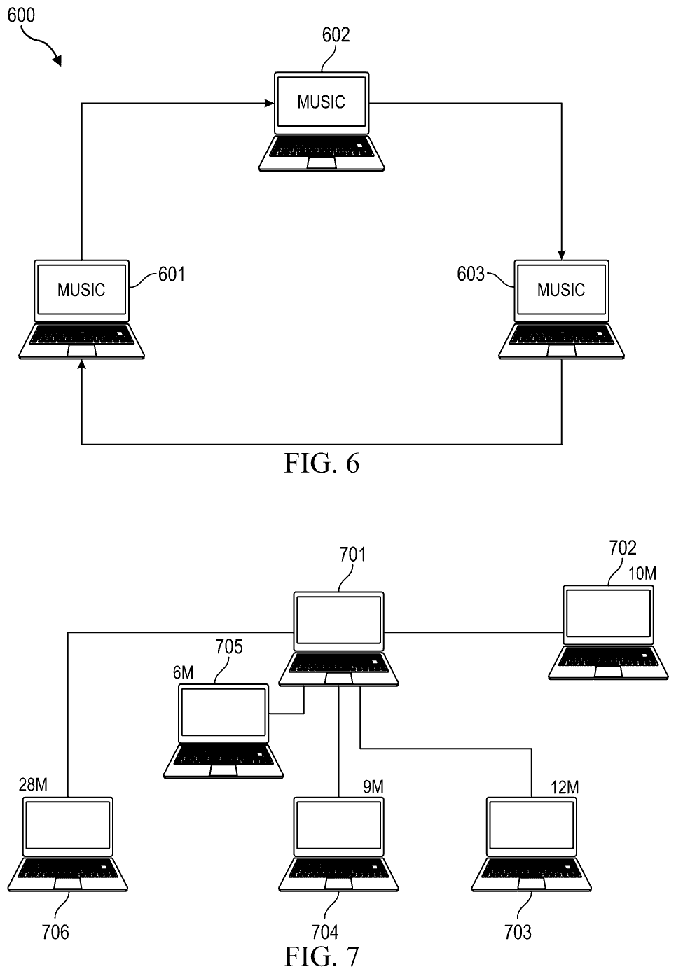

FIG. 6 illustrates an example use case showing multiple devices 601-603 collaborating in a group 600 to share music. Devices 601-603 may be laptops, tablets, media players, or other IHS devices. Devices 601-603 share a common advertisement packet that can be discovered by both Bluetooth and Wi-Fi type scanners on the other devices. Each device 601-603 has a middleware component or software service that allows for CLPA to be enabled on the advertisement packets. CLPA may be enabled on-demand, such as when a music application or media software is launched on a device 601-603. The CLPA information may provide information, such as a social discovery channel, that allows devices 601-603 to connect and share or synchronize music or other media. This would allow for multi-device coordination of music playback, for example, and allow the individual devices 601-603 to function as speakers for other devices.

FIG. 7 illustrates another example use case showing a group of devices 701-706 that are distributed apart from each other by varying distances. Devices 601-603 may be laptops, tablets, smart phones, or other IHS devices. Similar to the example of FIG. 6, devices 701-706 have a middleware component or software service that allows for CLPA to be enabled on the advertisement packets. Devices 701-706 share a common advertisement packet that can be discovered by both Bluetooth and Wi-Fi type scanners on the other devices. In one embodiment, device 701 may be an infrastructure component, access point, or wireless docking station to which the other devices 702-706 connect. CLPA may be used to trigger certain services or transport depending on the location of devices 702-706 and their respective distance from device 701. For example, devices 702-705 that are within a close range, such as within 15 m, may be directed by CLPA to communicate with device 701 using a low power channel, such as BLE, while farther range device 706 is directed by CLPA to use a Wi-Fi channel to connect to device 701.

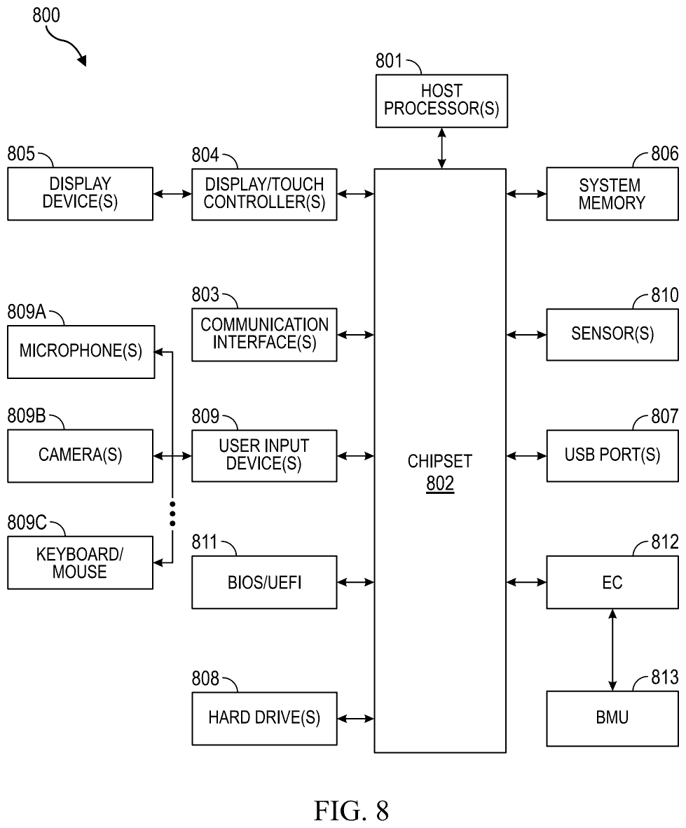

FIG. 8 shows an example of an Information Handling System (IHS) 800 configured to implement systems and methods described herein for creating, sharing, receiving, and responding to a common advertisement packet that can be discovered on multiple radio scanner types, such as Bluetooth and Wi-Fi. IHS 800 or a similar device may be used as IHS 101, 102 (FIG. 1), Provider 301, Seeker 302 (FIG. 2), GATT Server 400 (FIG. 4), Devices 502-504 (FIG. 5), Devices 601-603 (FIG. 6), or Devices 701-706 (FIG. 7).

FIG. 8 is a block diagram of components of IHS 800. As depicted, IHS 800 includes host processor(s) 801. In various embodiments, IHS 800 may be a single-processor system, or a multi-processor system including two or more processors. Host processor(s) 801 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 800 includes chipset 802 coupled to host processor(s) 801. Chipset 802 may provide host processor(s) 801 with access to several resources. In some cases, chipset 802 may utilize a QuickPath Interconnect (QPI) bus to communicate with host processor(s) 801. Chipset 802 may also be coupled to communication interface(s) 803 to enable communications between IHS 800 and various wired and/or wireless networks, such as Ethernet, WiFi, BT, cellular or mobile networks (e.g., Code-Division Multiple Access or “CDMA,” Time-Division Multiple Access or “TDMA,” Long-Term Evolution or “LTE,” etc.), satellite networks, or the like. In one embodiment, Wi-Fi radios 103, 105, and Bluetooth radios 104, 106 (FIG. 1) correspond to a configuration interface 803 that enable wireless communication.

Communication interface(s) 803 may be used to communicate with peripheral devices (e.g., BT speakers, microphones, headsets, etc.). Moreover, communication interface(s) 803 may be coupled to chipset 802 via a Peripheral Component Interconnect Express (PCIe) bus, or the like.

Chipset 802 may be coupled to display and/or touchscreen controller(s) 804, which may include one or more Graphics Processor Units (GPUs) on a graphics bus, such as an Accelerated Graphics Port (AGP) or PCIe bus. As shown, display controller(s) 804 provide video or display signals to one or more display device(s) 805.

Display device(s) 805 may include Liquid Crystal Display (LCD), Light Emitting Diode (LED), organic LED (OLED), or other thin film display technologies. Display device(s) 805 may include a plurality of pixels arranged in a matrix, configured to display visual information, such as text, two-dimensional images, video, three-dimensional images, etc. In some cases, display device(s) 805 may be provided as a single continuous display, rather than two discrete displays.

Chipset 802 may provide host processor(s) 801 and/or display controller(s) 804 with access to system memory 806. In various embodiments, system memory 806 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 802 may also provide host processor(s) 801 with access to one or more Universal Serial Bus (USB) ports/controllers 807, to which one or more peripheral devices may be coupled (e.g., integrated or external webcams, microphones, speakers, etc.).

Chipset 802 may further provide host processor(s) 801 with access to one or more hard disk drives, solid-state drives, optical drives, or other removable-media drives 808.

Chipset 802 may also provide access to one or more user input devices 809, for example, using a super I/O controller or the like. Examples of user input devices 809 include, but are not limited to, microphone(s) 809a, camera(s) 809b, and keyboard/mouse 809c. Other user input devices 809 may include a touchpad, stylus or active pen, totem, etc. Each user input device 809 may include a respective controller (e.g., a touchpad may have its own touchpad controller) that interfaces with chipset 802 through a wired or wireless connection (e.g., via communication interfaces(s) 803).

In some cases, chipset 802 may also provide access to one or more user output devices (e.g., video projectors, paper printers, 3D printers, loudspeakers, audio headsets, Virtual/Augmented Reality (VR/AR) devices, etc.).

In certain embodiments, chipset 802 may further provide an interface for communications with one or more hardware sensors 810. Sensors 810 may be disposed on or within the chassis of IHS 800, or otherwise coupled to IHS 800, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

BIOS/UEFI 811 is coupled to chipset 802. UEFI was designed as a successor to BIOS, and many modern IHSs utilize UEFI in addition to or instead of a BIOS. Accordingly, BIOS/UEFI 811 is intended to also encompass a UEFI component. BIOS/UEFI 811 provides an abstraction layer that allows the OS to interface with certain hardware components that are utilized by IHS 800.

Upon booting of IHS 800, host processor(s) 801 may utilize program instructions of BIOS 811 to initialize and test hardware components coupled to IHS 800, and to load a host OS for use by IHS 800. Via the hardware abstraction layer provided by BIOS/UEFI 811, software stored in system memory 806 and executed by host processor(s) 801 can interface with I/O devices coupled to IHS 800.

Embedded Controller (EC) 812 (sometimes referred to as a Baseboard Management Controller or “BMC”) includes a microcontroller unit or processing core dedicated to handling selected IHS operations not ordinarily handled by host processor(s) 801.

Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 800, EC 812 may be made operational from the very start of each power reset, before other devices are fully running or powered on. As such, EC 812 may be responsible for interfacing with a power adapter to manage the power consumption of IHS 800. These operations may be utilized to determine the power status of IHS 800, such as whether IHS 800 is operating from battery power or is plugged into an AC power source. Firmware instructions utilized by EC 812 may be used to manage other core operations of IHS 800 (e.g., turbo modes, maximum operating clock frequencies of certain components, etc.).

In some cases, EC 812 may implement operations for detecting certain changes to the physical configuration or posture of IHS 800 and managing other devices in different configurations of IHS 800. For instance, when IHS 800 as a 2-in-1 laptop/tablet form factor, EC 812 may receive inputs from a lid position or hinge angle sensor 810, and it may use those inputs to determine: whether the two sides of IHS 800 have been latched together to a closed position or a tablet position, the magnitude of a hinge or lid angle, etc. In response to these changes, the EC may enable or disable certain features of IHS 800 (e.g., front or rear facing camera, etc.).

In some implementations, EC 812 may be installed as a Trusted Execution Environment (TEE) component to the motherboard of IHS 800. Additionally, or alternatively, EC 812 may be further configured to calculate hashes or signatures that uniquely identify individual components of IHS 800. In such scenarios, EC 812 may calculate a hash value based on the configuration of a hardware and/or software component coupled to IHS 800. For instance, EC 812 may calculate a hash value based on all firmware and other code or settings stored in an onboard memory of a hardware component.

Hash values may be calculated as part of a trusted process of manufacturing IHS 800 and may be maintained in secure storage as a reference signature. EC 812 may later recalculate the hash value for a component may compare it against the reference hash value to determine if any modifications have been made to the component, thus indicating that the component has been compromised. As such, EC 812 may validate the integrity of hardware and software components installed in IHS 800.

In addition, EC 812 may provide an Out-of-Band communication channel that allows an Information Technology Decision Maker (ITDM) or Original Equipment Manufacturer (OEM) to manage IHS 800's various settings and configurations, for example, by issuing OOB commands.

In various embodiments, IHS 800 may be coupled to an external power source through an AC adapter, power brick, or the like. The AC adapter may be removably coupled to a battery charge controller to provide IHS 800 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) 813 may be coupled to EC 812 and it may include, for example, an Analog Front End (AFE), storage (e.g., non-volatile memory), and a microcontroller. In some cases, BMU 813 may be configured to collect and store information, and to provide that information to other IHS components.

Examples of information collectible by BMU 813 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc.

Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 800 may not include all the components shown in FIG. 8. Furthermore, some components that are represented as separate components in FIG. 8 may instead be integrated with other components, such that all or a portion of the operations executed by the illustrated components may instead be executed by the integrated component.

For example, in various embodiments described herein, host processor(s) 801 and/or other components shown in FIG. 8 (e.g., chipset 802, display controller(s) 804, communication interface(s) 803, EC 812, etc.) may be replaced by other devices. As such, IHS 800 may assume different form factors including, but not limited to: servers, workstations, desktops, laptops, appliances, video game consoles, tablets, smartphones, etc.

In one embodiment, a device comprises a first radio associated with a first wireless interface, a second radio associated with a second wireless interface, and at least one processor coupled to the first radio and the second radio. The at least one processor is configured to cause the device to scan the first wireless interface for advertisement messages, and to receive an advertisement message from a remote station, the advertisement message comprising information identifying a service available via the second radio and identifying a social channel on the second wireless interface to establish the service.

In some embodiments of the device, one wireless interface is a Bluetooth interface and another wireless interface is a Wi-Fi interface. A Bluetooth radio can be used to discover an infrastructure device, and a Wi-Fi Direct discovery can be triggered by a context in the advertisement message.

The service may be associated with a low power mode of the device, with a location of the device wherein the location may be a distance between the device and the remote station, with motion of the device, and/or with an application running on the device.

The at least one processor may be further configured to cause the device to exchange discovery messages with the remote station on the social channel on the second wireless interface.

The advertisement message may be a Contextual Low Power Advertisement (CLPA) message that uses an organization identifier field to define the service available and uses a channel information field to specify a service-related discovery channel. The CLPA message may be sent over a Bluetooth interface or over a Wi-Fi interface.

The device may further comprise multiple antennas associated with the first radio, and the at least one processor may further cause the device to select one of the multiple antennas to scan the first wireless interface for the advertisement messages and not using other of the multiple antennas to scan.

The at least one processor may be further configured to cause the device to place the second radio in an off or standby state while scanning the first wireless interface for advertisement messages using the first radio and to place the second radio in an on state after the social channel is identified.

The device may be an Information Handling System (IHS), an access point, a wireless docking station, an infrastructure device, or a collaboration bar.

In another embodiment, an apparatus comprises one or more processors and one or more computer-readable storage media having computer-executable instructions stored thereon. When executed by the one or more processors, the instructions cause the processors to advertise a service on a first wireless interface, wherein the service is provided via a second wireless interface, and wherein the second wireless interface is a higher power interface than the first wireless interface, wherein the service is advertised using a message format that can be used by both Bluetooth and Wi-Fi radios. The instructions further cause the processors to receive response information via the first wireless interface, wherein the response information indicates a subscription to the service from a wireless station and to provide instructions to establish a data path to support the service via the second wireless interface. The one or more processors may be further configured to establish a peer-to-peer connection on the second wireless interface.

The service can be advertised using a Contextual Low Power Advertisement (CLPA) message that uses an organization identifier field to define the service available and uses a channel information field to specify a service-related discovery channel.

The one or more processors may be further configured to place a radio for the second wireless interface in an off or standby state while advertising the service and to place the radio in an on state when the response information indicates a subscription to the service.

The apparatus may be an access point, a wireless docking station, an infrastructure device, or a collaboration bar.

The service may be associated with one or more of a low power mode, a location of the wireless station, a distance to the wireless station, motion of the wireless station or the apparatus, and an application running on the wireless station.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A device, comprising:
a first radio associated with a first wireless interface;
a second radio associated with a second wireless interface; and
at least one processor coupled to the first radio and the second radio, wherein the at least one processor is configured to cause the device to:
scan the first wireless interface for advertisement messages; and
receive an advertisement message from a remote station, the advertisement message comprising information identifying a service available via the second radio and identifying a social channel on the second wireless interface to establish the service.

2. The device of claim 1, wherein the service is associated with a low power mode of the device.

3. The device of claim 1, wherein the service is associated with a location of the device.

4. The device of claim 3, wherein the location is a distance between the device and the remote station.

5. The device of claim 1, wherein the service is associated with motion of the device.

6. The device of claim 1, wherein the service is associated with an application running on the device.

7. The device of claim 1, wherein the at least one processor is further configured to cause the device to:
exchange discovery messages with the remote station on the social channel on the second wireless interface.

8. The device of claim 1, wherein the advertisement message is a Contextual Low Power Advertisement (CLPA) message that uses an organization identifier field to define the service available and uses a channel information field to specify a service-related discovery channel.

9. The device of claim 8, wherein the CLPA message is sent over a Bluetooth interface or over a Wi-Fi interface.

10. The device of claim 1, wherein one wireless interface is a Bluetooth interface and another wireless interface is a Wi-Fi interface.

11. The device of claim 1, further comprising:
multiple antennas associated with the first radio; and
wherein the at least one processor is further configured to cause the device to:
select one of the multiple antennas to scan the first wireless interface for the advertisement messages and not using other of the multiple antennas to scan.

12. The device of claim 1, wherein the at least one processor is further configured to cause the device to:
place the second radio in an off or standby state while scanning the first wireless interface for advertisement messages using the first radio; and
place the second radio in an on state after the social channel is identified.

13. The device of claim 1, wherein the device is an Information Handling System (IHS), an access point, a wireless docking station, an infrastructure device, or a collaboration bar.

14. The device of claim 1, wherein a Bluetooth radio is used to discover an infrastructure device, and a Wi-Fi Direct discovery is triggered by a context in the advertisement message.

15. An apparatus, comprising:
one or more processors; and
one or more computer-readable storage media having computer-executable instructions stored thereon that, when executed by the one or more processors, cause the processors to:
advertise a service on a first wireless interface, wherein the service is provided via a second wireless interface, and wherein the second wireless interface is a higher power interface than the first wireless interface, wherein the service is advertised using a message format that can be used by both Bluetooth and Wi-Fi radios;
receive response information via the first wireless interface, wherein the response information indicates a subscription to the service from a wireless station; and
provide instructions to establish a data path to support the service via the second wireless interface.

16. The apparatus of claim 15, wherein the one or more processors are further configured to:
establish a peer-to-peer connection on the second wireless interface.

17. The apparatus of claim 15, wherein the service is advertised using a Contextual Low Power Advertisement (CLPA) message that uses an organization identifier field to define the service available and uses a channel information field to specify a service-related discovery channel.

18. The apparatus of claim 15, wherein the one or more processors are further configured to:
place a radio for the second wireless interface in an off or standby state while advertising the service; and
place the radio in an on state when the response information indicates a subscription to the service.

19. The apparatus of claim 15, wherein the apparatus is an access point, a wireless docking station, an infrastructure device, or a collaboration bar.

20. The apparatus of claim 15, wherein the service is associated with one or more of:
a low power mode;
a location of the wireless station;
a distance to the wireless station;
motion of the wireless station or the apparatus; and
an application running on the wireless station.
